(19) United States
(12) Patent Application Publication
(10) Pub. No.: US 2018/0109155 A1
(43) Pub. Date: Apr. 19, 2018

(54) Stator Slot Configurations For Electric Machines

(71) Applicant: Ford Global Technologies, LLC, Dearborn, MI (US)

(72) Inventors: Alfredo R. Munoz, Ann Arbor, MI (US); Feng Liang, Troy, MI (US); Michael W. Degner, Novi, MI (US)

(21) Appl. No.: 15/292,191

(22) Filed: Oct. 13, 2016

(51) Int. Cl. H02K 3/12; H02K 1/14; H02K 1/27; H02K 3/30

(52) U.S. Cl. CPC H02K 3/12; H02K 3/30; H02K 1/2706; H02K 1/146

(57) ABSTRACT

An electric machine may include a rotor. The electric machine may include a stator surrounding the rotor having teeth defining slots having at least two cross-sectional areas housing windings having uniform cross-sectional areas that fill each of the cross-sectional areas of the slots to substantially similar proportions relative to other slots such that slots housing windings having different phases have different cross-sectional areas than slots housing windings having same phases.

### TECHNICAL FIELD

This disclosure relates to stator slots of electric machines.

### BACKGROUND

Electric machines may include a rotor affixed to a rotating shaft. The rotor may have permanent magnets or conductors embedded therein generating, or capable of generating a magnetic field. An opposing magnetic field may be generated by a stator to generate torque or electricity, depending on whether the electric machine is in a generating or propelling mode. The stator may include a plurality of windings woven throughout slots defined by a plurality of teeth. The windings may be multi-layered to the harmonic fluxes generated by the stator winding. The introduction of multi-layered windings may impose vacant regions in the stator core.

### SUMMARY

An electric machine may include a rotor. The electric machine may include a stator surrounding the rotor. The stator has teeth defining slots having at least two cross-sectional areas housing windings having uniform cross-sectional areas that fill each of the cross-sectional areas of the slots to substantially similar proportions relative to other slots such that the slots housing windings having different phases have different cross-sectional areas than the slots housing windings having same phases.

A stator may include a plurality of windings each assigned with a phase. The stator may further include teeth defining slots evenly and circumferentially distributed about the stator. A first set of the slots is sized to house two layers of the windings having different phases and an insulator separating the different phases. A second set of the slots is sized to house two layers of the windings having same phases. The first set has a width greater than the second set.

An electric machine may include a stator surrounding a rotor having teeth defining slots having a first cross-sectional area sized to house windings having a same phase and a second cross-sectional area sized to house windings of different phases separated by an insulator. The first cross-sectional area and second cross-sectional area are sized to house windings having a uniform cross-sectional area and fill respective proportions of the cross-sectional areas to a necked area of the slot leading to a slot depression or opening.

### BRIEF DESCRIPTION OF THE DRAWINGS

FIG. 1 is a plan view of an electric machine having a shaft, rotor, and stator;

FIG. 2 is a cross-sectional view of a slot of the stator having windings inserted therein;

FIG. 3 is a cross-sectional view of an elongated cross-section of a stator including a plurality of teeth and slots, wherein some of the slots have different depths than other slots;

FIG. 4 is a cross-sectional view of an elongated cross-section of a stator including a plurality of teeth and slots, wherein some of the slots have different widths than other slots;

FIG. 5 is a cross-sectional view of an elongated cross-section of a stator including a plurality of teeth and slots, wherein some of the slots have different cross-sectional areas than other slots and the number of slots per pole per phase is fractional.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electric machines include a stator and a rotor to generate electricity or originate torques. The stator of the electric machine may be comprised of a plurality of stacked laminations. The laminations may be made of electric steel or other iron alloys. The laminations may have teeth that define slots and an inner diameter. Conductive windings may be wound throughout the slots to carry electric current. The slots may be sized (i.e., have a cross-sectional area sized) to house the windings. The relative cross-sectional area of the teeth and slots may be designed to provide maximum torque density. Increasing the cross-sectional area of the teeth provides increased channeling of magnetic flux, thereby improving torque density. Increasing the cross-sectional area of the slots allows the cross-sectional area of the windings to increase, thereby reducing resistive copper losses. Therefore, stators may be designed to maximize the cross-sectional area of the teeth and the cross-sectional area of the slots.

Windings may be used to conduct electric current through the slots in the stator iron core, which induces the magnetic field. The windings may be one solid conductor. The windings may be a plurality of individual conductors. The individual conductors may have squared or rounded cross-sections. The windings or individual conductors may have a coating (e.g., varnish, epoxy, resin, paint) to prevent cross-conduction between individual conductors. The windings may have the same cross-sectional areas to maintain uniform copper losses.

Electric machines may have multiple phases. The windings of different phases may be separated by an insulator to prevent short circuits between the windings because the electric potential between different phases may overcome insulation provided by ambient air and the varnish between the windings. The insulator may be phase insulation paper. The windings may be stacked in layers within the slots to improve the electric machine performance. These layered configurations (e.g., double-layer, two-layer, three-layer) may prevent cross-conduction between the windings by interposing an insulator between adjacent windings having dissimilar phases. Only slots with different phases require an insulator between windings of different phases. Slots with the same phases do not need an insulator. The use of insulators in slots having different phases may require a reduction in the overall cross-sectional area of the windings because the slot size remains constant. The reduction results in unused space in slots having same phase windings because the windings do not require an insulator. Meaning, cross-sectional area of slots with the same phases are underutilized. Therefore, the cross-sectional area of the slots may be adjusted to eliminate the waste of the space in the slots.

A reduction in the cross-sectional area of the slots allows the thickness of the teeth to be increased. All of the teeth of the stator may have the same width. The increase in width from each of reduced slots can be equally disbursed and distributed to all of the teeth. The increased tooth width will provide greater torque density of the electric machine.

The cross-sectional area of slots housing windings with the same phases may be adjusted in many ways. The depth of the slots may be reduced. The width of the slots may be lessened. Both the depth and width may be adjusted proportionately. The slots housing windings of the same phase may be adjusted in any manner such that the slot has a minimum cross-sectional area needed for housing the windings. The windings of both the insulator and non-insulator slots may proportionately fill the slots. The slots may not be filled to the absolute maximum capacity resulting in the windings spilling into the air gap. The slots may be filled to a threshold or the necked portion of the slot. The slots may be filled such that the entire cross-sectional area of the slot up to the air gap is fully utilized, more than 90% filled with a combination of windings and insulation.

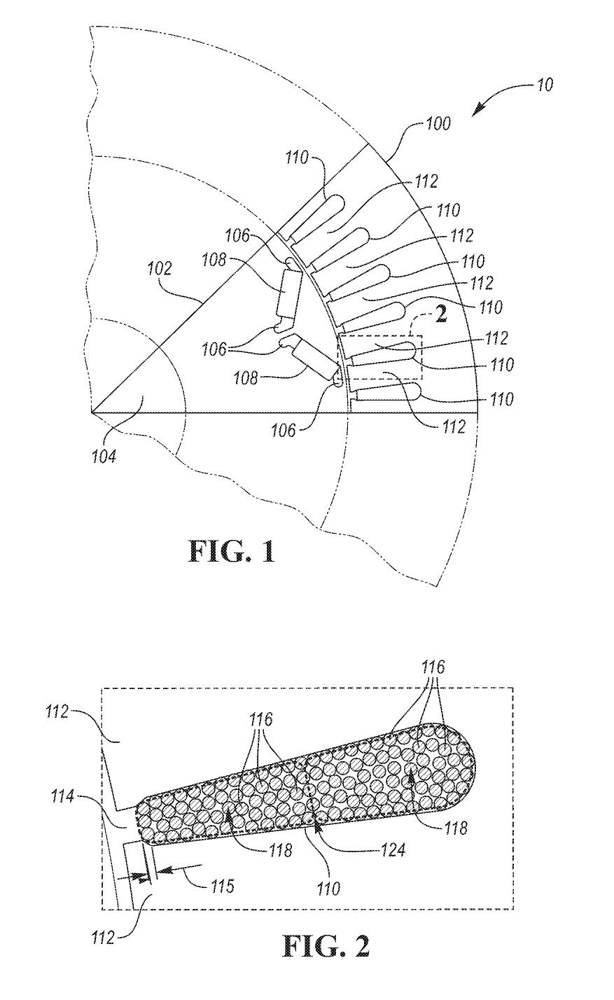

Now referring to FIG. 1, a portion of an electric machine 10 is shown. The electric machine 10 includes a stator 100 surrounding a rotor 102, which is mechanically connected to a shaft 104. The shaft 104 may be mechanically connected to the rotor 102 through a key and slot pair (not shown). The rotor 102 may include pockets 106 sized to house permanent magnets 108. The permanent magnets 108 may be paired to form magnetic poles. The stator may include a plurality of slots 110 defined by teeth 112. The number of slots 110 may be related to the number of permanent magnet 108 pairs such that the slots per pole per phase is a whole number or fractional number. Other electric machine 10 configurations may be used. For example, the rotor 102 may not include permanent magnets 108 (e.g., induction motor). The electric machine 10 may also have an external rotor 102 surrounding the stator 100. The rotor 102 may include different permanent magnet 108 configurations or include a plurality of permanent magnets 108 layered to generate poles.

Now referring to FIG. 2, a slot 110 of the stator 100. The slot 110 may be defined by a pair of teeth 112. The slot 110 may have a slot opening 114. The slot opening 114 may include a slot necked portion 115 where the slot 110 begins to taper to the slot opening 114. The slot 110 may house a plurality of conductors 116. The conductors 116 may be any shape. The conductors 116 may be circular, square, solid, or a combination thereof. The conductors 116 may be bundled in phases 118. Each phase 118 may have a plurality of conductors 116. Each phase may have insulation (not shown) to prevent short circuits with the stator teeth and lamination 112. As shown, each phase 118 has a similar or uniform cross-sectional area. The cross-sectional area may be measured as πr², L×W, another method, or combination thereof. The cross-sectional area 124 of the slot 110 may be sized to house the phases 118 such that the slot 110 is filled regardless of the presence or absence of insulation. Because a slot 110 may not be filled through the slot opening 114, a slot 110 may be considered full when a proportion of the slot 110 is filled. Meaning, less than 90% of the cross-sectional area of the slot is filled or another proportion amount of the slot is filled. A typical application using individual conductors may have a fill of 45%. A typical application using a bar winding may have a fill of 60-70%. The slot 110 shape and size may vary between different stator 100 designs. The slot 110 shape may be rectangular with straight sides, be rectangular with curved sides, be teardrop shaped with curved sides, or any other combination of shapes sized to house windings. For this reason, the exact fill percentage may vary between slots 110, depending on the slot 110 shape and proportions. Therefore, the fill percentage may be compared to the fill of a slot 110 of a stator 100 having an insulator embedded between the phase bundles 118. A dimensional value may, additionally, measure the fill. For example, the distance from the bundles to the air gap, slot opening, or slot necked portion 115 may be measured. The fill may vary slightly between slots 110 having insulators and not having insulators.

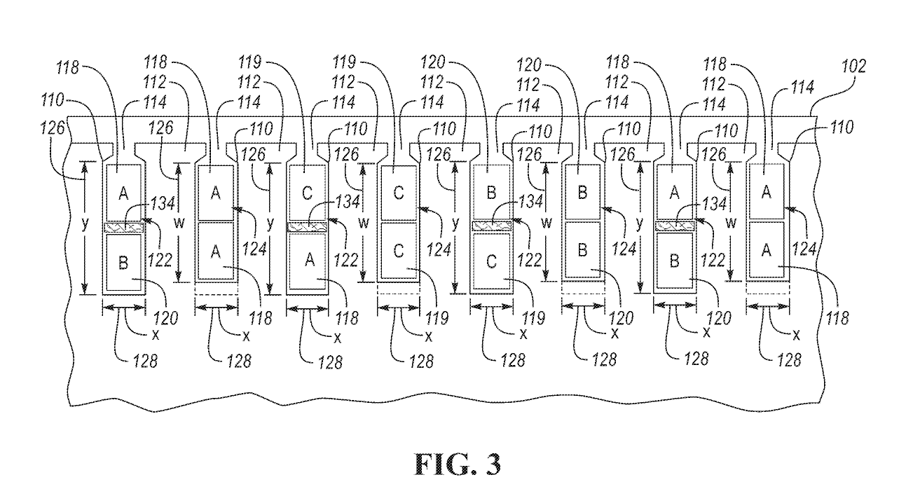

Now referring to FIG. 3, an elongated stator 100 is shown having a plurality of slots 110. The slots 110 may have varying cross-sectional areas 122, 124 to ensure the windings similarly fill the slots 110. The slots 110 are shown being defined by teeth 112. The teeth 112 form a slot opening 114. Each of the slots is filled with two phase bundles 118, 119, 120. The slots may be filled with more than two phase bundles 118, 119, 120. The slots 110 housing different phases 118, 119, 120 may have an insulator 134 disposed therein. The slot depth 126, y, of slots 110 housing different phases 118, 119, 120 may be longer than the depth 132, w, of slots 110 housing same phases 118, 119, 120. The width 128, x, of slots 110 housing different phases 118, 119, 120 may be the same as the width 128, x, of slots 110 housing same phases 118, 119, 120. The differing depths 126, 132 of the slots 110 ensures a first set 122 of slots 110 has a different cross-sectional area than a second set 124 of slots 110. Windings 118, 119, 120 housed within each of the slots 110 fill each of the slots 110.

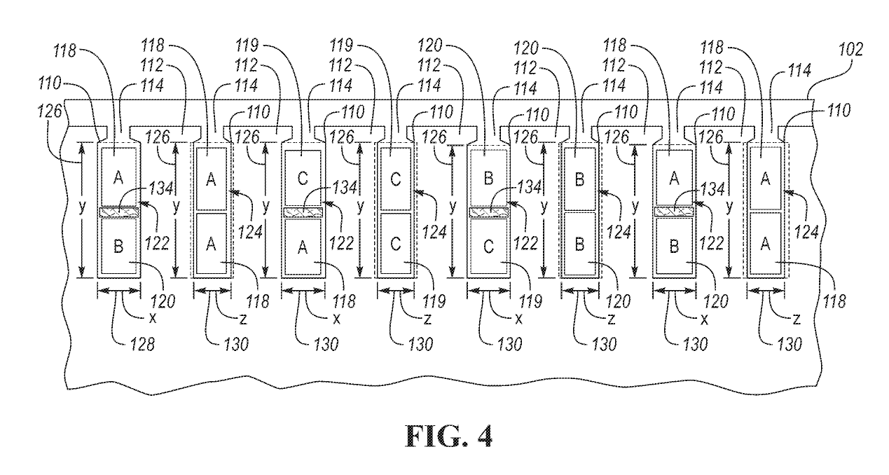

Now referring to FIG. 4, an elongated stator 100 is shown having a plurality of slots 110. The winding configuration of the stator 100 is an example of an integer-slot winding having 2 slots-per-pole-phase. The slots 110 may have varying cross-sectional areas 122, 124 to ensure the windings similarly fill the slots 110. The slots 110 are shown being defined by teeth 112. The teeth 112 form a slot opening 114. Each of the slots is filled with two phase bundles 118, 119, 120. The slots may be filled with more than two phase bundles 118, 119, 120. The slots 110 housing different phases 118, 119, 120 may have an insulator 134 disposed therein. The slot depth 126, y, of slots 110 housing different phases 118, 119, 120 may be the same as the length 126, y, of slots 110 housing same phases 118, 119, 120. The width 128, x, of slots 110 housing different phases 118, 119, 120 may be greater than the width 130, z, of slots 110 housing same phases 118, 119, 120. The differing widths 126, 130 of the slots 110 ensures a first set 122 of slots 110 has a different cross-sectional area than a second set 124 of slots 110. A stator 100 having this configuration may have wider teeth 112 because slots 110 housing the same phase 118, 119, 120 are thinner. Wider teeth may increase the torque density of the electric machine. In other embodiments, the width and depth of slots 110 housing same phases 118, 119, 120 may be adjusted such that the cross-sectional area of the windings 118, 119, 120 fill the cross-sectional area, or substantially fill cross-sectional area, of the slot 110.

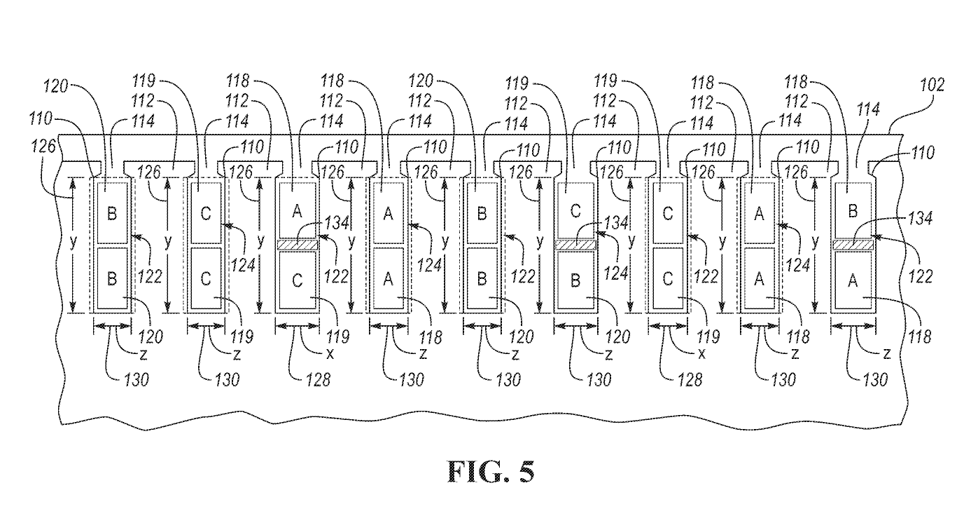

Now referring to FIG. 5, an elongated stator 100 is shown having a plurality of slots 110. The winding configuration of the stator is an example of a fractional-slot winding having 1.5 slots-per-pole-per-phase. This fractional-slot winding example results in two slots 110 having same phases located adjacent to one another instead of an alternating fashion as shown by the integer-slot winding example shown in FIG. 4. The slots 110 may have varying cross-sectional areas 122, 124 to ensure the windings similarly fill the slots 110. The slots 110 are shown being defined by teeth 112. The teeth 112 form a slot opening 114. Each of the slots is filled with two phase bundles 118, 119, 120. The slots may be filled with more than two phase bundles 118, 119, 120. The slots 110 housing different phases 118, 119, 120 may have an insulator 134 disposed therein. The slot depth 126, y, of slots 110 housing different phases 118, 119, 120 may be the same as the length 126, y, of slots 110 housing same phases 118, 119, 120. The width 128, x, of slots 110 housing different phases 118, 119, 120 may be greater than the width 130, z, of slots 110 housing same phases 118, 119, 120. The differing width 128, 130 of the slots 110 ensures the slots 110 have different cross-sectional areas 122, 124 and windings 118, 119, 120 housed within each of the slots 110 fill each of the slots 110. A stator 100 having this configuration may have wider teeth 112 because slots 110 housing the same phase 118, 119, 120 are thinner. Wider teeth may increase the torque density of the electric machine. In other embodiments, the width and depth of slots 110 housing same phases 118, 119, 120 may be adjusted such that the cross-sectional area of the windings 118, 119, 120 fill the cross-sectional area, or substantially fill cross-sectional area, of the slot 110.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electric machine comprising:
a rotor; and
a stator surrounding the rotor and including teeth defining slots having at least two cross-sectional areas housing windings having uniform cross-sectional areas that fill each of the cross-sectional areas of the slots to substantially similar proportions relative to other slots such that the slots housing windings having different phases have different cross-sectional areas than the slots housing windings having same phases.

2. The electric machine of claim 1, wherein the windings having different phases are separated by an insulator.

3. The electric machine of claim 2, wherein the insulator is phase insulation paper.

4. The electric machine of claim 1, wherein a width of the slots housing windings having different phases is greater than a width of slots housing windings of the same phase.

5. The electric machine of claim 4, wherein a depth of the slots housing windings having different phases and a depth of slots housing windings of the same phase is same.

6. The electric machine of claim 1, wherein a slots per pole per phase of the stator is integer.

7. The electrical machine of claim 1, wherein a width of each of the teeth is same.

8. The electrical machine of claim 1, wherein the substantially similar proportions is less than 90 percent of the cross-sectional area of the slot.

9. The electrical machine of claim 8, wherein the cross-sectional area of the slot is defined by an inner diameter of the stator and the teeth.

10. A stator comprising:
a plurality of windings having individually assigned phases; and
teeth defining slots evenly and circumferentially distributed about the stator, a first set of the slots sized to house two layers of the windings having different phases and an insulator separating the different phases, a second set of the slots sized to house two layers of the windings having same phases, and the first set having a width greater than the second set.

11. The stator of claim 10, wherein a depth of the slots housing windings having different phases and a depth of slots housing windings of the same phase is same.

12. The stator of claim 10, wherein the slots of the first set have a larger cross-sectional area than slots of the second set.

13. The stator of claim 12, wherein the windings fill the cross-sectional areas of both the first set and second set to substantially equal proportions.

14. The stator of claim 13, wherein the windings fill the cross-sectional area of both the first set and second set to a necked portion of the slot.

15. An electric machine comprising:
a stator surrounding a rotor having teeth defining slots having a first cross-sectional area sized to house windings having a same phase and a second cross-sectional area sized to house windings of different phases separated by an insulator, wherein the first cross-sectional area and second cross-sectional area are sized to house windings having a uniform cross-sectional area and fill respective proportions of the cross-sectional areas to a necked area of the slot leading to a slot opening.

16. The electric machine of claim 15, wherein a width of the slots sized to house windings having different phases is greater than a width of slots sized to house windings of the same phase.

17. The electric machine of claim 16, wherein a depth of the slots sized to house windings having different phases and a depth of slots sized to house windings of the same phase is same.

18. The electric machine of claim 15, wherein the slots of the stator per pole of the rotor per phase of the stator is fractional.

19. The electrical machine of claim 15, wherein the respective proportions is less than 90 percent of the cross-sectional area of the slot.

20. The electrical machine of claim 19, wherein the cross-sectional area of the slot is defined by an inner diameter of the stator and the teeth.
